(19) United States
(12) Patent Application Publication
(10) Pub. No.: US 2014/0192994 A1
(43) Pub. Date: Jul. 10, 2014

(54) Noise Cancelling Headphone

(71) Applicants: Roger Chen, Temple City, CA (US); Shuguang Sun, Shenzhen (CN)

(72) Inventors: Roger Chen, Temple City, CA (US); Shuguang Sun, Shenzhen (CN)

(21) Appl. No.: 13/734,912

(22) Filed: Jan. 4, 2013

(51) Int. Cl. H04R 1/10

(52) U.S. Cl. CPC H04R 1/1083
USPC 381/71.6

(57) ABSTRACT

A noise cancelling headphone includes a headphone body, a audio player and a central processing unit. The headphone body includes a headband, a first speaker unit and a second speaker unit. The elongated headband is bent and shaped to fittedly and adjustably wear on a user's head, wherein the headband has a first and a second end portion. The first speaker unit and the second speaker unit are attached on the first and the second end portion of the headband respectively. The audio player is provided on the headphone body, and is arranged to read a predetermined kind of audio signals. The central processing unit is received in the headphone body, and is arranged to process the audio signals outputted from the audio player and drive the first speaker unit and the second speaker unit to generate corresponding audible sound.

### BACKGROUND OF THE PRESENT INVENTION

1. Field of Invention

The present invention relates to a headphone, and more particularly to a noise cancellation headphone comprising an audio player, which is capable of inputting audio signals to the headphone so that a user is able to listen to music played by the audio player directly through the headphone.

2. Description of Related Arts

A conventional noise cancellation headphone usually comprises a headband, a left and a right speaker unit, and a processing circuitry provided in the headband or the speaker units for processing audio signals inputted thereto. The processing circuitry comprises noise-cancellation circuit which aims to reduce or counter noise from the ambient environment when the noise cancellation headphone is operated. As such, when a user wears the headphone and listen to music, he or she will only be minimally affected by the background noise.

There are several disadvantages related to the above-mentioned conventional noise cancellation headphone. First, the noise cancellation headphone is meant for connecting to an external audio player. Thus, the user may connect the noise cancellation headphone to an external MP3 player, an external DVD player, or even a home theater system for listening to the audio data stored in the corresponding medium. When the noise cancellation headphone is disconnected from such an external electronic device, it cannot produce audible sound.

Second, the conventional noise cancellation headphones do not have remote control function because there is nothing for the user to control. As mentioned earlier, a conventional noise cancellation headphone always relies on external audio players as a source of audio signals. As a result, in order to adjust the various playing parameters of audible sound, one actually needs to command the audio player, not the headphone. This presents a problem to most users because not all audio players have remote control. For example, a typical MP3 player does not have an accompanying remote control because the MP3 player is designed to be held by the user. However, when the MP3 player is placed in a user's handbag but she wants to adjust music volume, she has to manually take the MP3 player from her handbag and perform the necessary adjustment. This is somewhat troublesome.

### SUMMARY OF THE PRESENT INVENTION

The invention is advantageous in that it provides a noise cancellation headphone comprising an audio player, which is capable of inputting audio signals to the headphone so that a user is able to listen to music played by the audio player directly through the headphone.

Another advantage of the invention is to provide a noise cancellation headphone comprising a remote control which is capable of wirelessly control the audio player so that the adjustment is promptly reflected in the audible sound generated by the noise cancellation headphone.

Another advantage of the invention is to provide a noise cancellation headphone comprising a noise cancellation circuitry which is capable of minimizing background noise from ambient environment when the noise cancellation headphone is in operation. Thus, the present invention provides the most quality audible sound played by a built-in audio player to a user of the present invention.

Another advantage of the invention is to provide a noise cancellation headphone comprising a Bluetooth module adapted for connecting to an external electronic device. In other words, the noise cancellation headphone of the present invention can be used in conjunction with a wide range of electronic devices.

Another advantage of the invention is to provide a noise cancellation headphone having a built-in audio player, which is arranged to accept external flash memory devices for playing pre-stored audio data.

Additional advantages and features of the invention will become apparent from the description which follows, and may be realized by means of the instrumentalities and combinations particular point out in the appended claims.

According to the present invention, the foregoing and other objects and advantages are attained by providing a noise cancelling headphone, comprising:

a headphone body, which comprises:

an elongated headband which is bent and shaped to fittedly and adjustably wear on a user's head, wherein said headband has a first and a second end portion; and a first speaker unit and a second speaker unit attached on said first and said second end portion of said headband respectively, wherein said first speaker unit and said second speaker unit are arranged to produce audible sound to a user;

an audio player which is provided on said headphone body, and is arranged to read a predetermined kind of audio signals; and

a central processing unit, which comprises a noise cancellation module, received in said headphone body, and is electrically connected to said first speaker unit, said second speaker unit and said audio player, wherein said central processing unit is arranged to process said audio signals outputted from said audio player and drive said first speaker unit and said second speaker unit to generate corresponding audible sound, so that a user is able to listen to music played by said audio player through said noise cancellation headphone.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a noise cancellation headphone according to a preferred embodiment of the present invention.

FIG. 2 is a schematic diagram of the noise cancellation headphone according to the above preferred embodiment of the present invention.

FIG. 3 is a circuit diagram of the noise cancellation module according to the above preferred embodiment of the present invention.

FIG. 4 is a circuit diagram of the Bluetooth and audio processing module according to the above preferred embodiment of the present invention.

FIG. 5A is a circuit diagram of the Bluetooth and audio processing module according to the above preferred embodiment of the present invention, illustrating section A shown in FIG. 4.

FIG. 5B is a circuit diagram of the Bluetooth and audio processing module according to the above preferred embodiment of the present invention, illustrating section B shown in FIG. 4.

FIG. 5C is a circuit diagram of the Bluetooth and audio processing module according to the above preferred embodiment of the present invention, illustrating section C shown in FIG. 4.

FIG. 5D is a circuit diagram of the Bluetooth and audio processing module according to the above preferred embodiment of the present invention, illustrating section D shown in FIG. 4.

FIG. 5E is a circuit diagram of the Bluetooth and audio processing module according to the above preferred embodiment of the present invention, illustrating section E shown in FIG. 4.

FIG. 6 is a circuit diagram of the remote control circuitry according to the above preferred embodiment of the present invention.

FIG. 7 is a schematic diagram of the remote control according to the above preferred embodiment of the present invention.

FIG. 8 is a block diagram of the noise cancellation headphone according to the above preferred embodiment of the present invention, illustrating the relationship between the audio player and the central processing unit.

### DETAILED DESCRIPTION OF THE PREFERRED EMBODIMENT

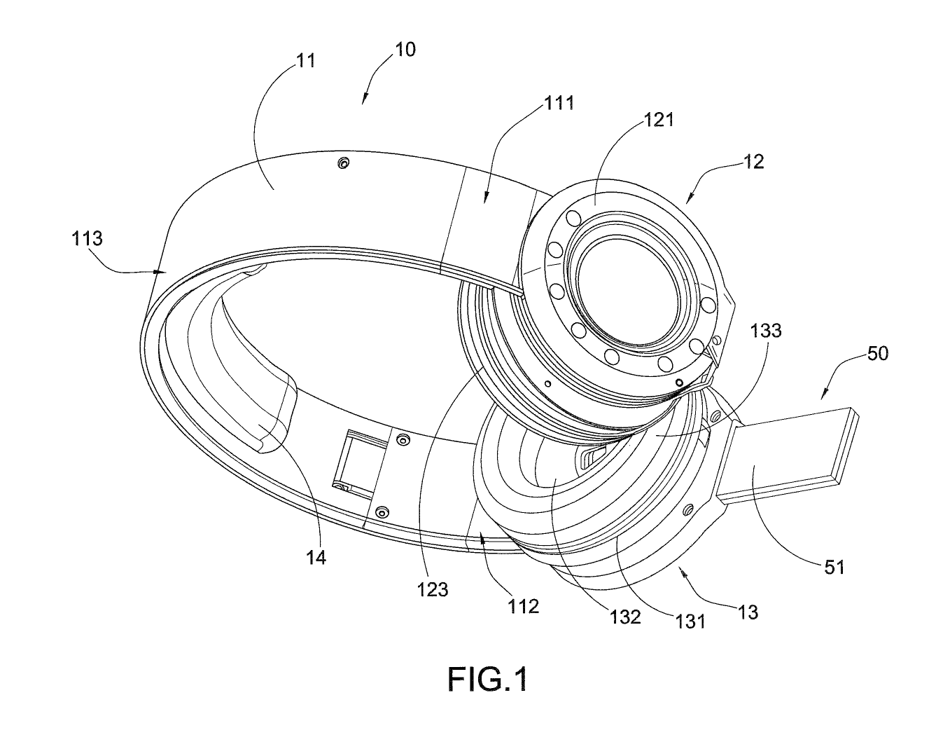

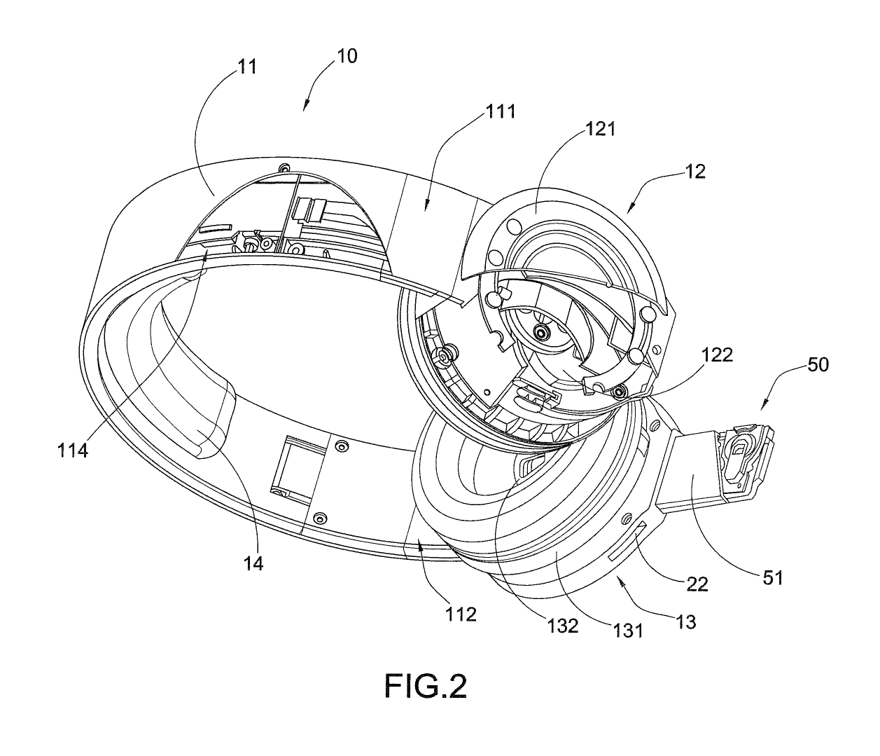

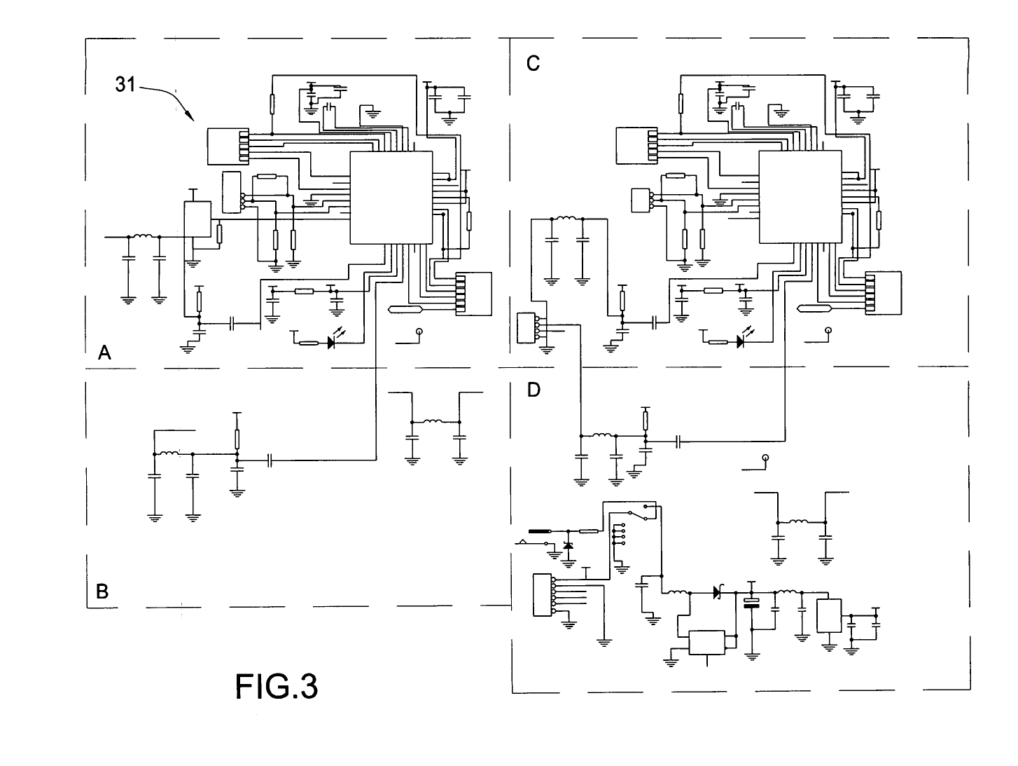

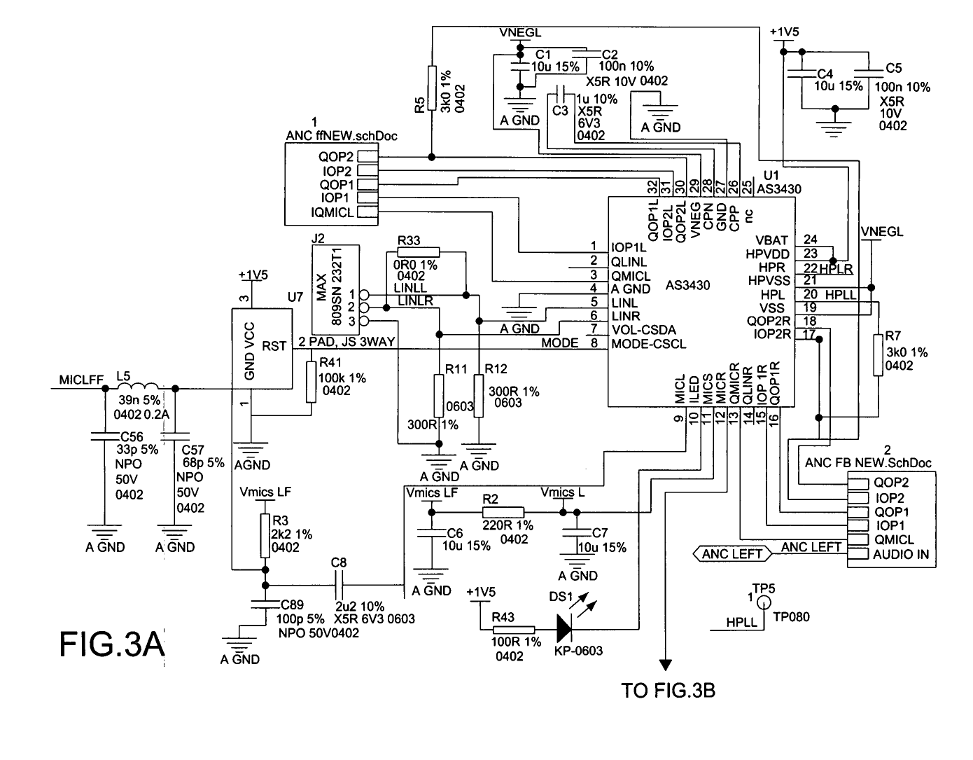

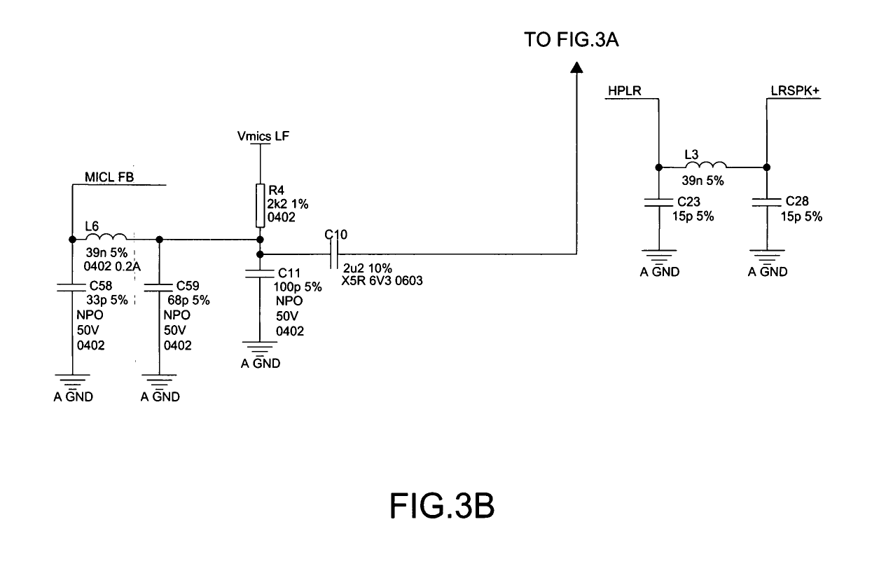

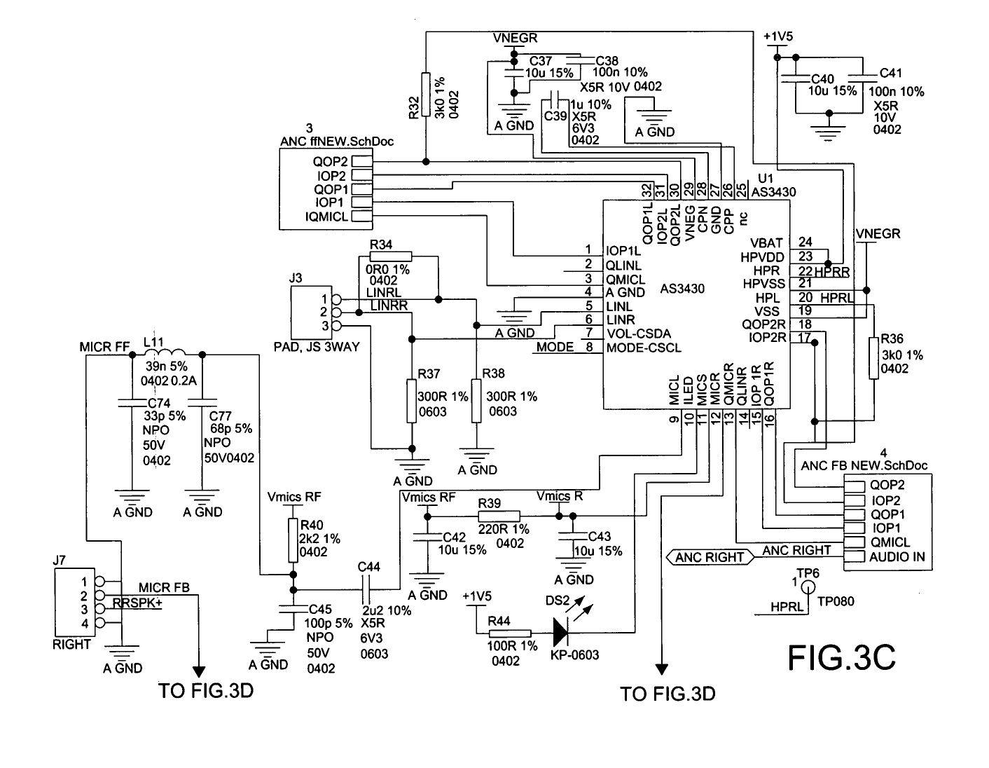

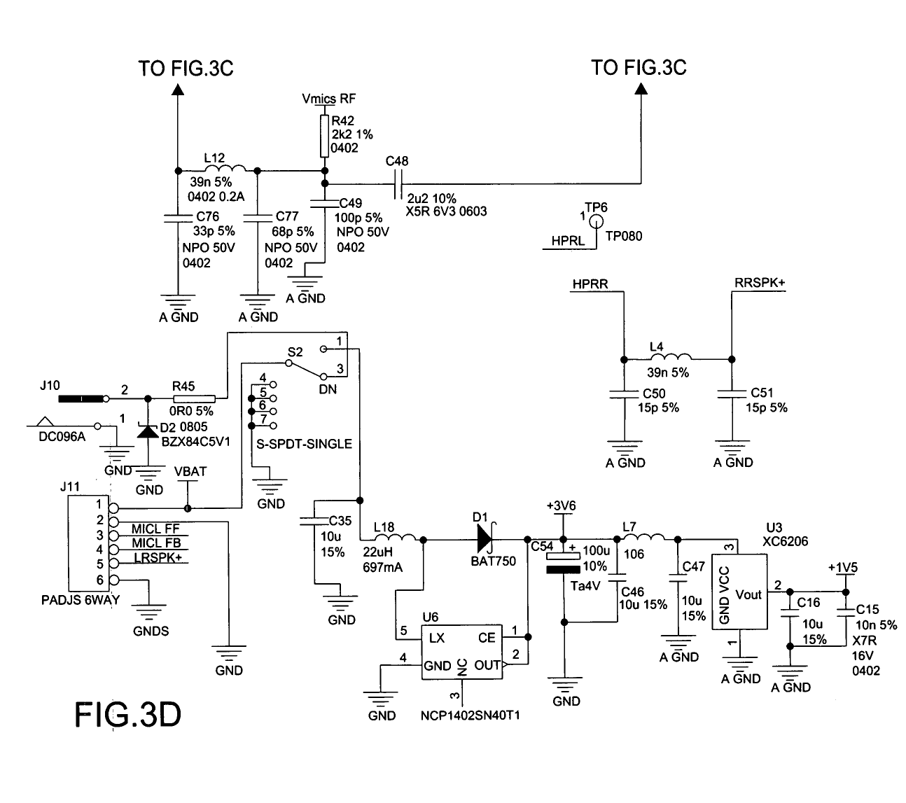

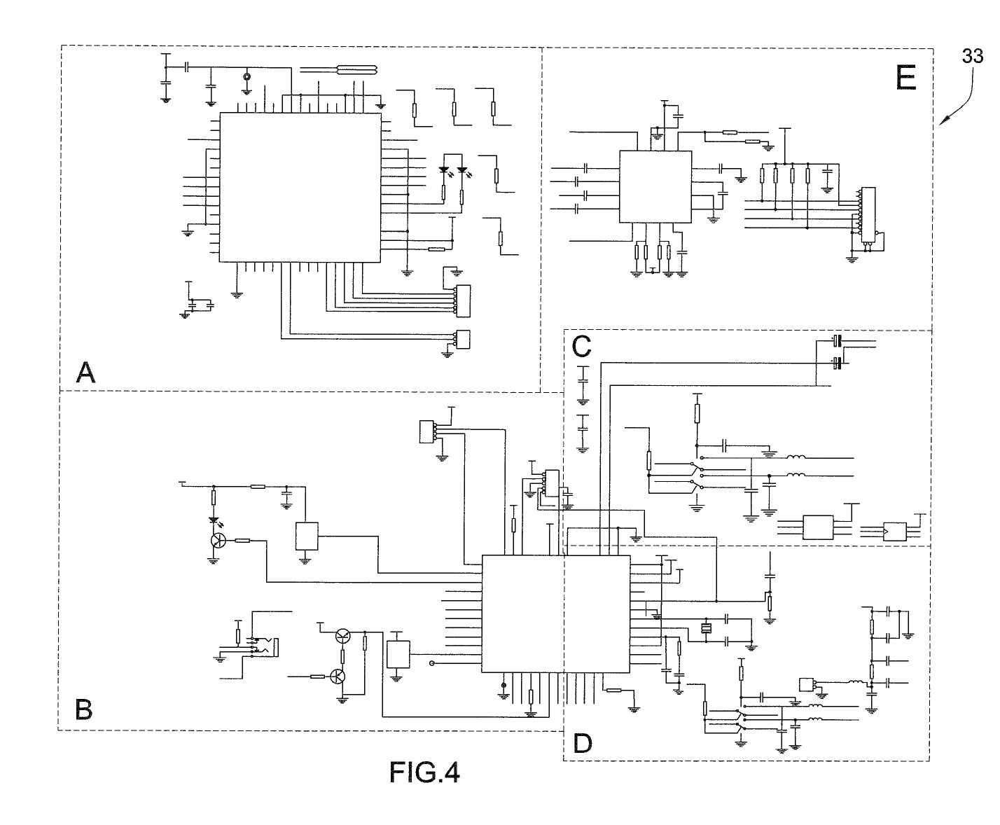

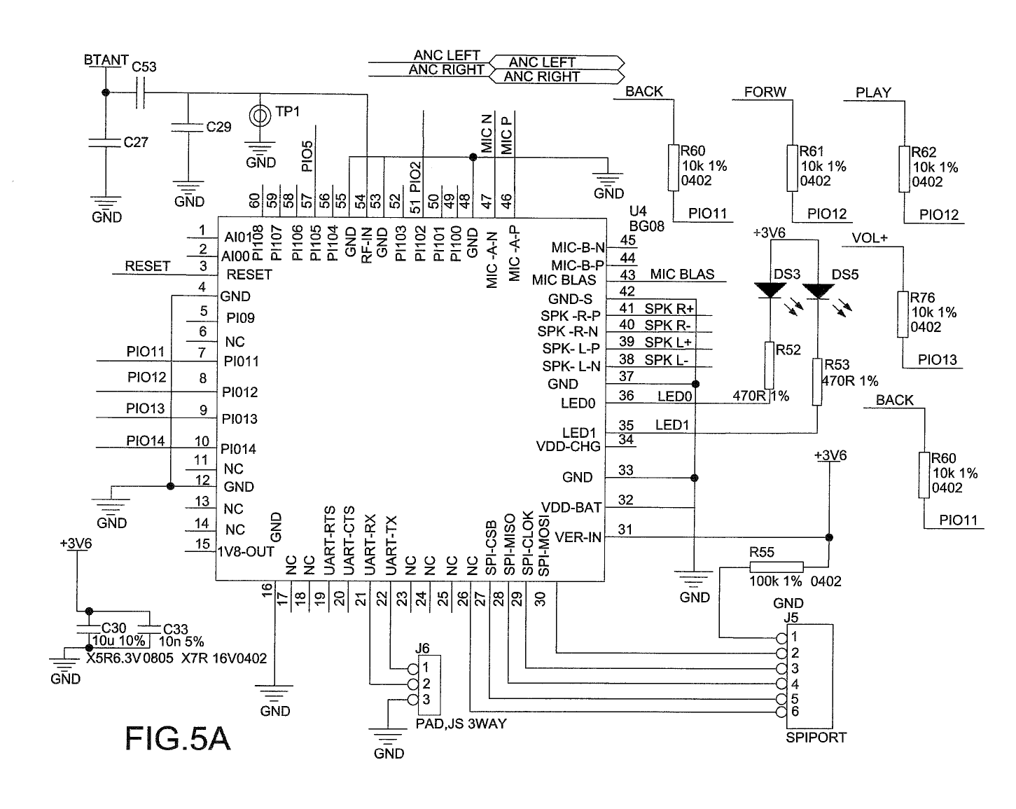

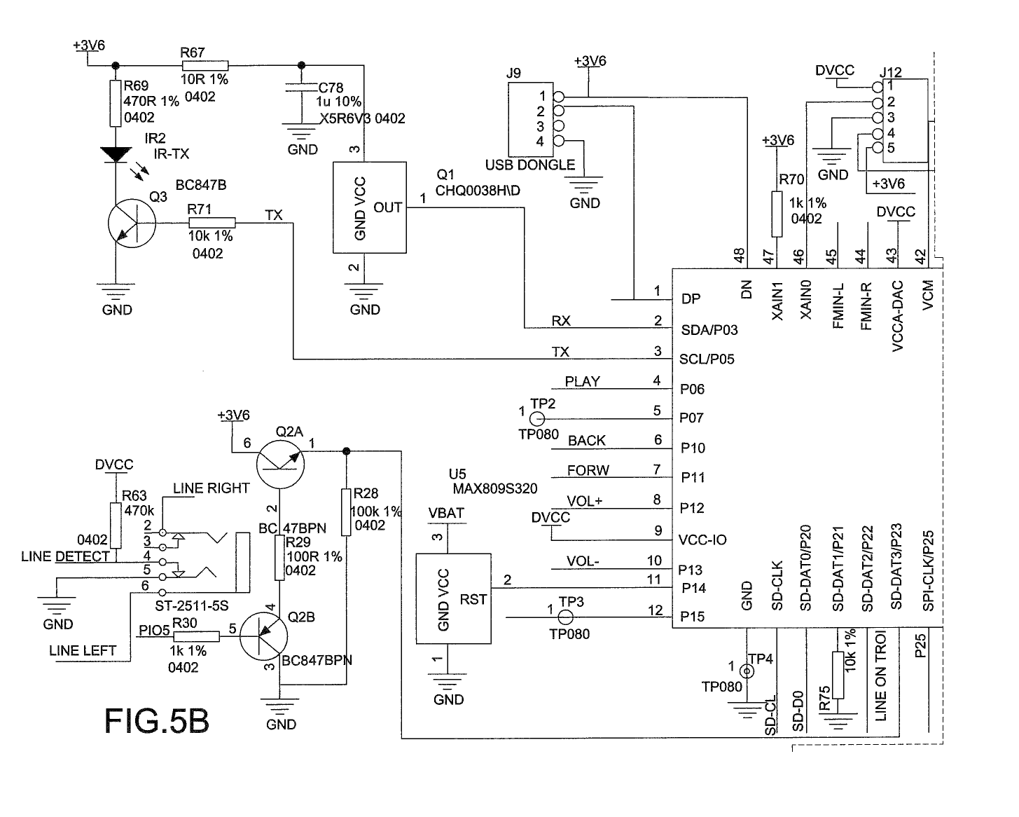

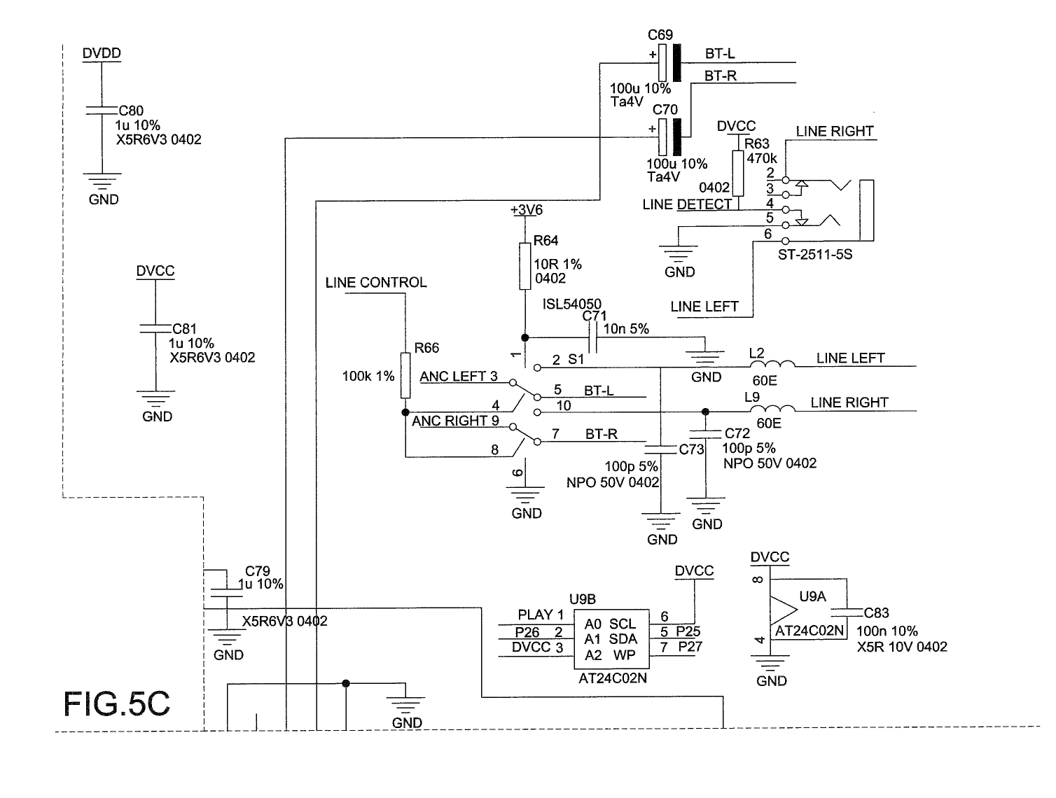

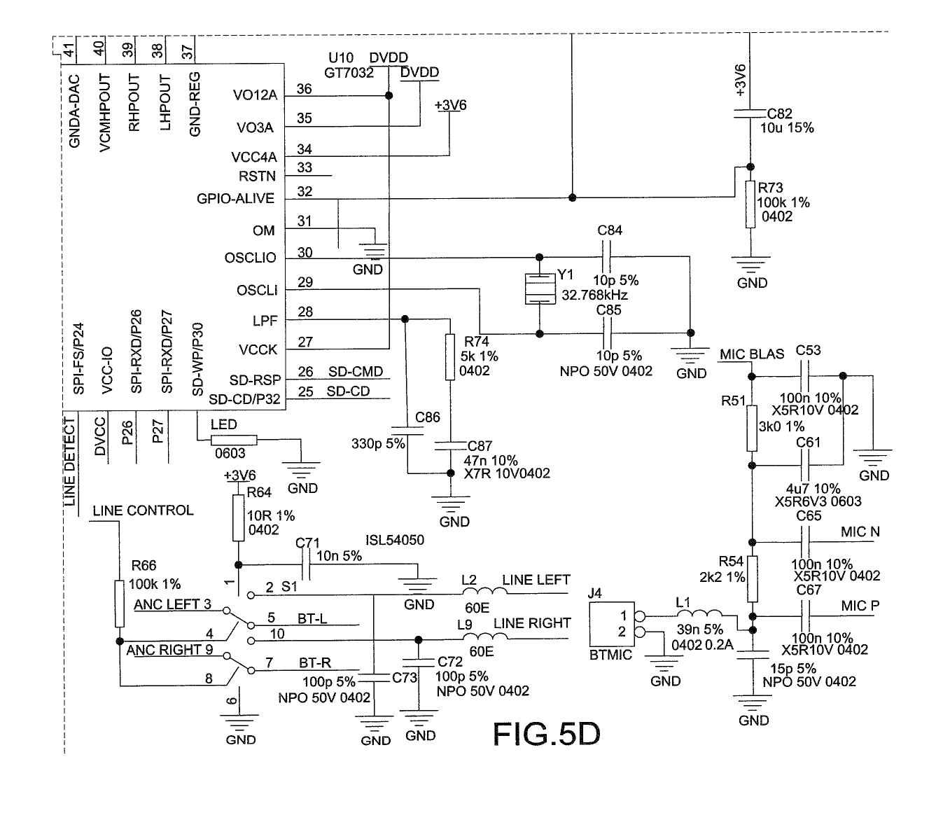

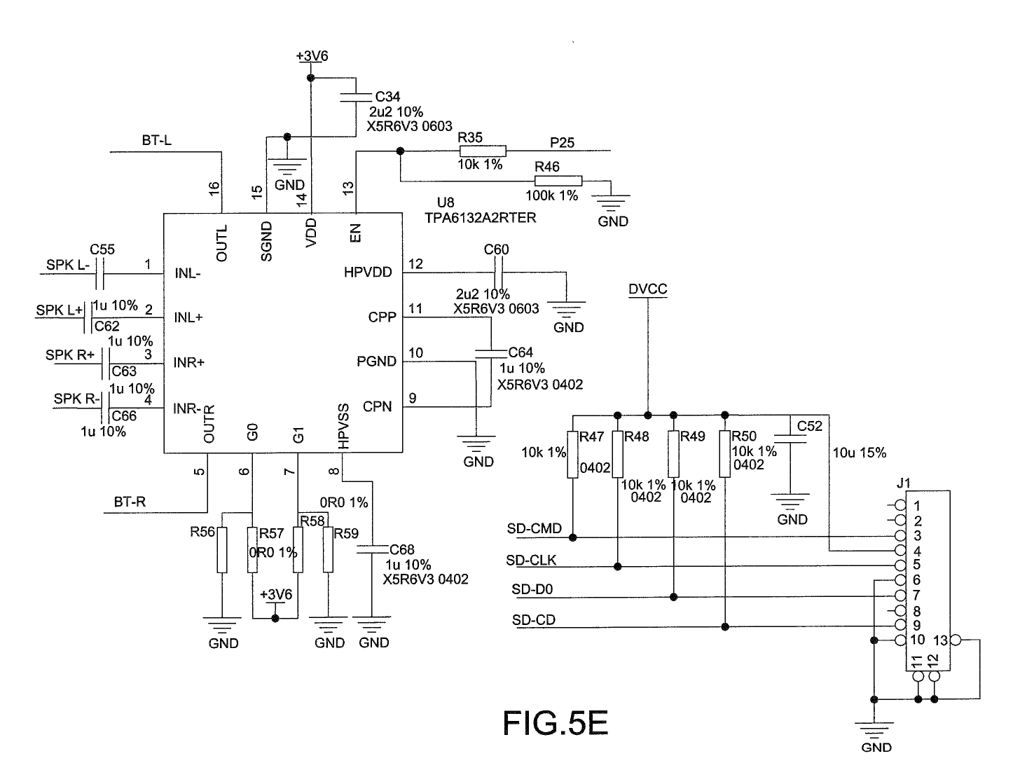

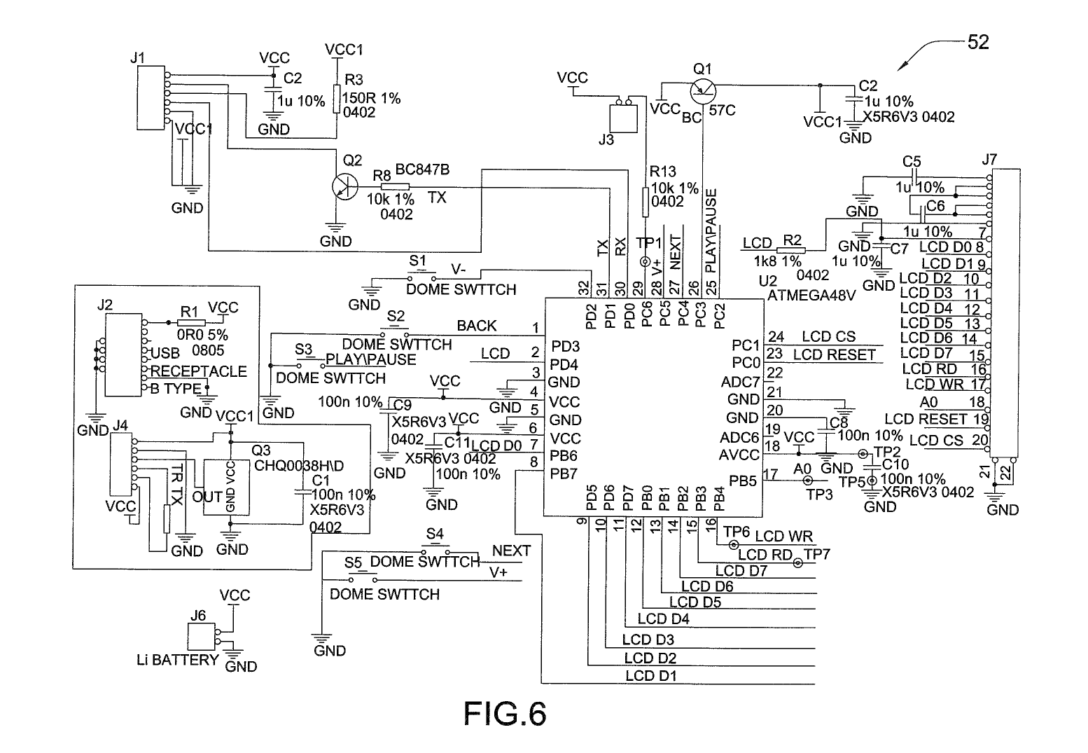

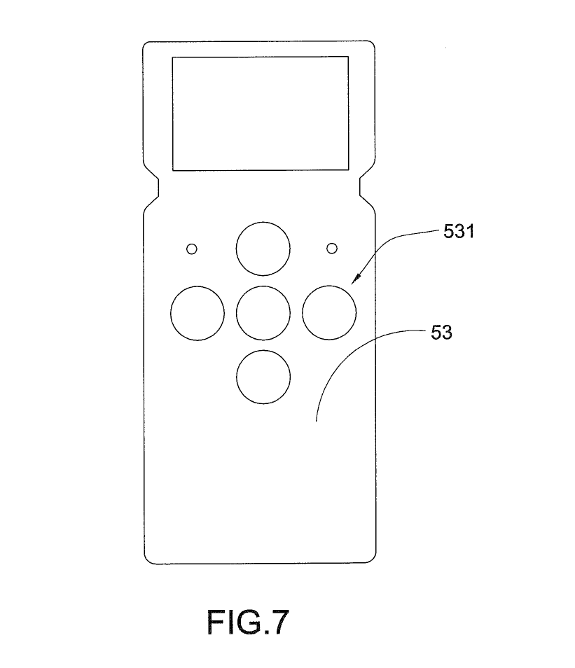

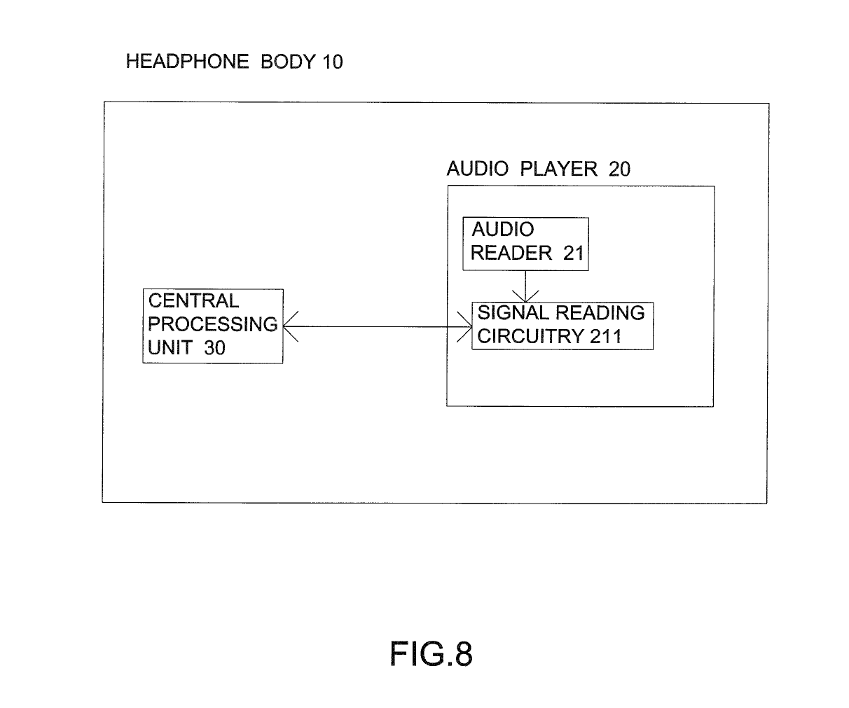

Referring to FIG. 1 to FIG. 4, FIG. 5A to FIG. 5E, and FIG. 6 to FIG. 8 of the drawings, a noise cancelling headphone according to a preferred embodiment of the present invention is illustrated, in which the noise cancellation headphone comprises a headphone body 10, an audio player 20, and a central processing unit 30.

The headphone body 10 comprises an elongated headband 11, a first speaker unit 12, and a second speaker unit 13. The elongated headband 11 is bent and shaped to fittedly and adjustably wear on a user's head, wherein the headband 11 has a first end portion 111 and a second end portion 112.

The first speaker unit 12 and the second speaker unit 13 are attached on the first end portion 111 and the second end portion 112 of the headband 11 respectively, wherein the first speaker unit 12 and the second speaker unit 13 are arranged to produce audible sound to a user. The audio player 20 is provided on the headphone body 10, and is arranged to read a predetermined kind of audio signals, such as MP3 data.

On the other hand, the central processing unit 30 comprises a noise cancellation module 31, and is received in the headphone body 10, and electrically connected to the first speaker unit 12, the second speaker unit 13 and the audio player 20, wherein the central processing unit 30 is arranged to process the audio signals outputted from the audio player 20 and drive the first speaker unit 12 and the second speaker unit 13 to generate corresponding audible sound, so that a user is able to listen to music played by the audio player 20 through the noise cancellation headphone of the present invention.

According to the preferred embodiment of the present invention, the headband 11 further has a main portion 113 moveably extended between the first end portion 111 and the second end portion 112, and a receiving cavity 114 formed in the headband 11, wherein electrical connection between the first speaker unit 11, the second speaker unit 12 and the central processing unit 30 are accomplished through wires extending in the receiving cavity 114. Note that the main portion 113 of the headband 11 is adjustably movable with respect to the first end portion 111 and the second end portion 112 so that an overall length of the headband 11 can be selectively adjusted to fit different users.

The first speaker unit 12 comprises a first speaker housing 121 provided at the first end portion 111 of the headband 11 and a first speaker 122 mounted in the first speaker housing 121 for delivering audio sound to the user. Similarly, the second speaker unit 13 comprises a second speaker housing 131 provided at the second end portion 112 of the headband 11 and a second speaker 132 mounted in the second speaker housing 131 also for delivering audible sound to the user. The first speaker 122 and the second speaker 132 are arranged to deliver audible sound to the user as controlled and commanded by the central processing unit 30.

Moreover, the headphone body 10 further comprises a headband holster 14 provided underneath the main portion 113 of the elongated headband 11 for providing cushion effect to the user when the noise cancellation headphone is worn on the user's head.

In order to enhance the entertainment experience to the user, the first speaker unit 12 further comprises a first earmuff 123 attached on an inner side of the first speaker housing 121 while the second speaker unit 13 further comprises a second earmuff 133 attached on an inner side of the second speaker housing 131, wherein the first earmuff 123 and the second earmuff 133 provide substantial cushion effect to the user's ears when the noise cancellation headphone is worn on the user's head.

The audio player 20 is provided in the headphone body 10, and comprises a data reader 21 provided in the headphone body 10 for reading a predetermined type of audio signals. The audio signals read by the audio reader 21 is transmitted to the central processing unit 30 for converting into corresponding audible sound. The audio reader 21 comprises a signal reading circuitry 211 and has a reader slot 22 formed on the headphone body 10, wherein a user is able to insert an external memory device, such as a micro SD card, into the reader slot 22 for inputting audio data, such as MP3 music files, into the signal reading circuitry 211 so that the MP3 music files can be processed by the central processing unit 30.

The central processing unit 30 is received in the headphone body 10 and comprises an active noise cancellation circuitry 31 for performing active noise cancellation when the headphone is being operated. The active noise cancellation circuitry 31 is arranged to counter or cancel background noise originated from the ambient environment when the headphone is operated.

Moreover, the central processing unit 30 further comprises an audio processing circuitry 32 provided in the headphone body 10 and is electrically connected to the audio player 20 for processing the audio signals read by the audio player 20. Note that the audio signals are preferably MP3 files. However, the audio signals can be embodied as any other files containing audio data.

The central processing unit 30 further comprises a Bluetooth module 33 arranged to wirelessly communicate to an external electronic device also having Bluetooth communication capability. For example, the Bluetooth module 33 can communicate and pair with the user's cellular phone so that the user is able to utilize the noise cancellation headphone of the present invention to make conversation. In such situation, the noise cancellation headphone further comprises a microphone 40 electrically connected to the central processing unit 30 for transmitting the user's voice to the external electronic device.

The noise cancellation headphone further comprises a remote control arrangement 50 arranged to facilitate remote control function for the noise cancellation headphone. More specifically, the remote control arrangement 50 comprises a remote control housing 51 attached on the headphone body 10, a remote control module 52 received in the remote control housing 51 and is electrically connected to the central processing unit 30, and a remote control unit 53 wirelessly communicated with the remote control module 52 for initiating remote control commands to the noise cancellation headphone. The remote control commands are wirelessly received by the remote control module 52 which is arranged to transmit the corresponding command to the central processing unit 30 for further execution.

Thus, the remote control unit 53 comprises remote control panel 531 formed thereon for allowing a user to control an operation of the noise cancellation headphone through operating on the control panel 531. By operating the remote control panel 531, the user is able to control the operation parameters of the audio player 20 so as to adjust, for example, a volume, of the audible sound delivered by the first speaker unit 12 and the second speaker unit 13.

The operation of the present invention is as follows: a user of the present invention may load a predetermined amount of MP3 files into the audio player 20 and the user may operate the remote control unit 53 to command the noise cancellation headphone. The user is then able to hear music stored in the MP3 files through the first speaker unit 12 and the second speaker unit 13.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A noise cancelling headphone, comprising:
a headphone body, which comprises:
an elongated headband which is bent and shaped to fittedly and adjustably wear on a user's head, wherein said headband has a first and a second end portion; and
a first speaker unit and a second speaker unit attached on said first and said second end portion of said headband respectively, wherein said first speaker unit and said second speaker unit are arranged to produce audible sound to a user;
an audio player which is provided on said headphone body, and is arranged to read a predetermined kind of audio signals; and
a central processing unit, which comprises a noise cancellation module, received in said headphone body, and is electrically connected to said first speaker unit, said second speaker unit and said audio player, wherein said central processing unit is arranged to process said audio signals outputted from said audio player and drive said first speaker unit and said second speaker unit to generate corresponding audible sound, so that a user is able to listen to music played by said audio player through said noise cancellation headphone.

2. The noise canceling headphone, as recited in claim 1, wherein said audio player comprises a data reader provided in said headphone body for reading a predetermined type of audio signals, wherein said audio signals read by said audio reader is transmitted to said central processing unit for converting into corresponding audible sound, wherein said audio reader comprises a signal reading circuitry and has a reader slot formed on said headphone body, wherein a user is able to insert an external memory device into said reader slot for inputting audio data.

3. The noise canceling headphone, as recited in claim 2, further comprising a remote control arrangement arranged to facilitate remote control function for said noise cancellation headphone, wherein said remote control arrangement comprises a remote control housing attached on said headphone body, a remote control module received in said remote control housing and is electrically connected to said central processing unit, and a remote control unit wirelessly communicated with said remote control module for initiating remote control commands to said noise cancellation headphone.

4. The noise canceling headphone, as recited in claim 3, wherein said remote control unit comprises remote control panel formed thereon for allowing a user to control an operation of said noise cancellation headphone through operating on said control panel.

5. The noise canceling headphone, as recited in claim 2, wherein said central processing unit is received in said headphone body and comprises an active noise cancellation circuitry for performing active noise cancellation when said noise cancellation headphone is operated.

6. The noise canceling headphone, as recited in claim 4, wherein said central processing unit is received in said headphone body and comprises an active noise cancellation circuitry for performing active noise cancellation when said noise cancellation headphone is operated.

7. The noise canceling headphone, as recited in claim 5, wherein said central processing unit further comprises an audio processing circuitry provided in said headphone body and is electrically connected to said audio player for processing said audio signals read by said audio player, wherein said audio signals are MP3 files.

8. The noise canceling headphone, as recited in claim 6, wherein said central processing unit further comprises an audio processing circuitry provided in said headphone body and is electrically connected to said audio player for processing said audio signals read by said audio player, wherein said audio signals are MP3 files.

9. The noise canceling headphone, as recited in claim 7, wherein said central processing unit further comprises a Bluetooth module arranged to wirelessly communicate to an external electronic device also having Bluetooth communication capability.

10. The noise canceling headphone, as recited in claim 8, wherein said central processing unit further comprises a Bluetooth module arranged to wirelessly communicate to an external electronic device also having Bluetooth communication capability.

11. The noise canceling headphone, as recited in claim 9, wherein said headband further has a main portion moveably extended between said first end portion and said second end portion, and a receiving cavity formed in said headband, wherein electrical connection between said first speaker unit, said second speaker unit and said central processing unit are accomplished through wires extending in said receiving cavity.

12. The noise canceling headphone, as recited in claim 10, wherein said headband further has a main portion moveably extended between said first end portion and said second end portion, and a receiving cavity formed in said headband, wherein electrical connection between said first speaker unit, said second speaker unit and said central processing unit are accomplished through wires extending in said receiving cavity.

13. The noise canceling headphone, as recited in claim 11, wherein said main portion of said headband is adjustably movable with respect to said first end portion and said second end portion so that an overall length of said headband is selectively adjustable.

14. The noise canceling headphone, as recited in claim 12, wherein said main portion of said headband is adjustably movable with respect to said first end portion and said second end portion so that an overall length of said headband is selectively adjustable.

15. The noise canceling headphone, as recited in claim 13, wherein said first speaker unit comprises a first speaker housing provided at said first end portion of said headband and a first speaker mounted in said first speaker housing for delivering audio sound to said user.

16. The noise canceling headphone, as recited in claim 14, wherein said first speaker unit comprises a first speaker housing provided at said first end portion of said headband and a first speaker mounted in said first speaker housing for delivering audio sound to said user.

17. The noise canceling headphone, as recited in claim 15, wherein said second speaker unit comprises a second speaker housing provided at said second end portion of said headband and a second speaker mounted in said second speaker housing for delivering audible sound to said user.

18. The noise canceling headphone, as recited in claim 16, wherein said second speaker unit comprises a second speaker housing provided at said second end portion of said headband and a second speaker mounted in said second speaker housing for delivering audible sound to said user.

19. The noise canceling headphone, as recited in claim 17, wherein said first speaker unit further comprises a first earmuff attached on an inner side of said first speaker housing while said second speaker unit further comprises a second earmuff attached on an inner side of said second speaker housing, wherein said first earmuff and said second earmuff provide substantial cushion effect to user's ears.

20. The noise canceling headphone, as recited in claim 18, wherein said first speaker unit further comprises a first earmuff attached on an inner side of said first speaker housing while said second speaker unit further comprises a second earmuff attached on an inner side of said second speaker housing, wherein said first earmuff and said second earmuff provide substantial cushion effect to user's ears.
